(19) United States
(12) Patent Application Publication
(10) Pub. No.: US 2025/0003283 A1
(43) Pub. Date: Jan. 2, 2025

(54) FRAME ASSEMBLY FOR A DOOR OR A WINDOW

(71) Applicant: Baywest Glazing Systems Inc., Langley (CA)

(72) Inventor: John Sawatzky, Langley (CA)

(21) Appl. No.: 18/214,954

(22) Filed: Jun. 27, 2023

(51) Int. Cl. E06B 3/263

(52) U.S. Cl. CPC E06B 3/263; E06B 2003/26325; E06B 2003/26378

(57) ABSTRACT

A frame assembly for a door or a window includes an inner frame portion, an outer frame portion spaced from the inner frame portion by one or more thermal breaks, and a first insulating and structural assembly positioned between the inner frame portion and the outer frame portion. The insulating and structural assembly includes heat-insulating portions for inhibiting the transfer of heat between the inner frame portion and the outer frame portion, and structural portions for retaining the inner frame portion in position relative to the outer frame portion. The inner frame portion and the outer frame portion define a longitudinal direction extending peripherally around the door or window. The heat-insulating portions alternate in the longitudinal direction with the structural portions.

### FIELD OF THE INVENTION

The present disclosure relates to framing and in particular to a frame assembly for a door or a window.

### BACKGROUND OF THE INVENTION

Because of its low weight, flexibility, and strength, aluminium is an ideal material for the construction of door and window frames. On the other hand, because of its relatively high heat conductivity, aluminium is also poor for insulating buildings from heat loss.

In order to solve this problem, it is known to split an aluminium frame into multiple different pieces that are spaced apart by air gaps or “thermal breaks”. Air is a good insulator of heat and therefore the thermal breaks improve the overall heat-insulating properties of the frame. However, by splitting apart the frame in this fashion, the structural properties of the frame may be compromised.

### SUMMARY OF THE INVENTION

According to a first aspect of the disclosure, there is provided a frame assembly for a door or a window, comprising: an inner frame portion; an outer frame portion spaced from the inner frame portion by one or more thermal breaks; and a first insulating and structural assembly positioned between the inner frame portion and the outer frame portion, and comprising: heat-insulating portions for inhibiting the transfer of heat between the inner frame portion and the outer frame portion; and structural portions for retaining the inner frame portion in position relative to the outer frame portion, wherein the inner frame portion and the outer frame portion define a longitudinal direction extending peripherally around the door or window, and wherein the heat-insulating portions alternate in the longitudinal direction with the structural portions.

The one or more thermal breaks may comprise one or more air gaps.

The frame assembly may further comprise a central frame portion respectively spaced from and between each of the inner frame portion and the outer frame portion by one or more thermal breaks, and wherein the structural portions further retain the inner frame portion and the outer frame portion in position relative to the central frame portion.

The heat-insulating portions may comprise: heat-insulating portions positioned between the inner frame portion and the central frame portion; and heat-insulating portions positioned between the central frame portion and the outer frame portion. The structural portions may comprise: structural portions securing the inner frame portion to the central frame portion; and structural portions securing the central frame portion to the outer frame portion.

The heat-insulating portions may comprise polystyrene foam.

The heat-insulating portions may be hollow portions of the frame assembly.

The structural portions may comprise one or both of a polyamide and glass fibre.

The inner frame portion and the outer frame portion may comprise features for mating with corresponding features in the structural portions.

The features of the inner frame portion and the outer frame portion, and the corresponding features in the structural portions, may be uncrimped.

At least one of the inner frame portion and the outer frame portion may comprise hooks for mating with corresponding grooves in the structural portions.

The structural portions may comprise hooks for mating with corresponding grooves in at least one of the inner frame portion and the outer frame portion.

The frame assembly may further comprise one or more gaskets sealing at least one of the one or more thermal breaks.

The one or more gaskets may include at least one gasket on an underside of the inner frame portion and the outer frame portion and comprising one or more downwardly extending protrusions for sealing against a threshold of the door or window.

At least one of the heat-insulating portions may be longer, in the longitudinal direction, than at least one of the structural portions.

Each of the heat-insulating portions may be longer, in the longitudinal direction, than each of the structural portions.

According to a further aspect of the disclosure, there is provided a door comprising: a sill; a frame assembly comprising: an inner frame portion; an outer frame portion spaced from the inner frame portion by one or more thermal breaks; and an insulating and structural assembly positioned between the inner frame portion and the outer frame portion, and comprising: heat-insulating portions for inhibiting the transfer of heat between the inner frame portion and the outer frame portion; and structural portions for retaining the inner frame portion in position relative to the outer frame portion, wherein the inner frame portion and the outer frame portion define a longitudinal direction extending peripherally around the door, and wherein the heat-insulating portions alternate in the longitudinal direction with the structural portions.

The door may further comprise at least one gasket on an underside of the inner frame portion and the outer frame portion and comprising a wedge-shaped portion receiving the sill.

The wedge-shaped portion may comprise one or more grooves or one or more protrusions formed therein for respectively receiving one or more protrusions or one or more ridges of the sill.

According to a further aspect of the disclosure, there is provided a method of making a frame for a door or a window, comprising: providing: an inner frame portion; an outer frame portion spaced from the inner frame portion by one or more thermal breaks; and an insulating and structural assembly between the inner frame portion and the outer frame portion, wherein providing the insulating and structural assembly comprises sliding, in a longitudinal direction defined by the inner frame portion and the outer frame portion, structural portions between the inner frame portion and the outer frame portion and such that the structural portions are spaced apart from one another in the longitudinal direction, wherein, as a result of sliding the structural portions between the inner frame portion and the outer frame portion, features on the structural portions mate with corresponding features on the inner frame portion and the outer frame portion and thereby retain the inner frame portion in position relative to the outer frame portion.

Sliding the structural portions may comprise: alternately sliding, in the longitudinal direction defined by the inner frame portion and the outer frame portion, heat-insulating portions and the structural portions between the inner frame portion and the outer frame portion, wherein the heat-insulating portions are for inhibiting the transfer of heat between the inner frame portion and the outer frame portion.

After sliding the structural portions between the inner frame portion and the outer frame portion, the features on the structural portions and the corresponding features on the inner frame portion and the outer frame portion may not crimped.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a cross-sectional view of a door comprising a door frame according to an embodiment of the disclosure;

FIG. 2 is a magnified view of a portion of the door frame of FIG. 1, showing a pair of shear blocks engaged with inner, central, and outer frame portions of the door frame, according to an embodiment of the disclosure;

FIG. 3 is a magnified, rotated view of a portion of the door frame of FIG. 1, showing a pair of insulating foam blocks between the inner, central, and outer frame portions of the door frame, according to an embodiment of the disclosure;

FIG. 4 shows inner, central, and outer frame portions of the door frame of FIG. 1, according to an embodiment of the disclosure;

FIGS. 5A and 5B show shear blocks and foam blocks being engaged with a central frame portion of a horizontal jamb, according to an embodiment of the disclosure;

FIG. 6 shows an alternating arrangement of shear blocks and insulating foam blocks, according to an embodiment of the disclosure;

FIGS. 7A and 7B show shear blocks and foam blocks being engaged with a central frame portion of a vertical jamb, according to an embodiment of the disclosure;

FIGS. 8A-8C show inner frame portions being engaged with the shear blocks of the horizontal and vertical jambs of FIGS. 5B and 7B, according to an embodiment of the disclosure;

FIGS. 9A and 9B show an exterior glazing gasket being added to the frame assembly of FIG. 8C, according to an embodiment of the disclosure;

FIGS. 10A and 10B show a glazing being added to the frame assembly of FIG. 9, according to an embodiment of the disclosure;

FIGS. 11A-11C show outer frame portions being engaged with the shear blocks of the horizontal and vertical jambs of FIGS. 5B and 7B, according to an embodiment of the disclosure;

FIGS. 12A and 12B show an interior glazing gasket being added to the frame assembly of FIG. 11C, according to an embodiment of the disclosure;

FIGS. 13A and 13B show a sash gasket being added to the frame assembly of FIG. 12, according to an embodiment of the disclosure; and

FIGS. 14A and 14B show a sill gasket being added to the frame assembly of FIG. 13, according to an embodiment of the disclosure.

### DETAILED DESCRIPTION OF THE INVENTION

The present disclosure seeks to provide improved frames for doors and windows. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a frame assembly for a door or a window. The frame assembly includes an inner frame portion and an outer frame portion. The inner frame portion may be a portion of the frame assembly that faces the interior of a building or structure once the door or window is installed therein. Conversely, the outer frame portion may be a portion of the frame assembly that faces the exterior of the interior of a building or structure once the door or window is installed therein. The outer frame portion is separated from, disconnected from, or otherwise spaced from the inner frame portion by one or more thermal breaks. Each thermal break may comprise, for example, an air gap that provides heat insulation between the inner frame portion and the outer frame portion.

An insulating and structural assembly is positioned between the inner frame portion and the outer frame portion. The insulating and structural assembly includes heat-insulating portions that may comprise, for example, foam (such as polystyrene foam) for inhibiting the transfer of heat between the inner frame portion and the outer frame portion. The insulating and structural assembly further includes structural portions that may comprise, for example, polyamide for retaining the inner frame portion in position relative to the outer frame portion. Together, the inner frame portion and the outer frame portion define a longitudinal direction extending peripherally around the door or window, and the heat-insulating portions alternate in the longitudinal direction with the structural portions. For example, the heat-insulating portions and the structural portions may be alternately slid or snapped into position between the inner frame portion and outer frame portion.

The structural portions have inferior insulating properties than the heat-insulating portions, but the heat-insulating portions provide less structural support than the structural portions. Therefore, by alternating the structural portions with the heat-insulating portions, heat-insulation may be maximized while still providing structural support for the door or window frame. According to some embodiments, the length of the heat-insulating portions in the longitudinal direction may be greater than the length of the structural portions, further increasing the heat-insulation.

The inner frame portion and the outer frame portion may comprise features for mating with or otherwise engaging corresponding features in the structural portions. For example, at least one of the inner frame portion and the outer frame portion may comprise hooks for mating with or otherwise engaging corresponding grooves in the structural portions, or the structural portions may comprise hooks for mating with or otherwise engaging corresponding grooves in at least one of the inner frame portion and the outer frame portion. Advantageously, such engagement of the structural portions with the inner and outer frame portions may obviate the need from crimping the structural portions and the inner and outer frame portions together which requires an additional manufacturing step.

According to some embodiments, one or more additional insulating and structural assemblies may be provided between the inner frame portion and the outer frame portion, for example to provide further heat-insulating and structural properties to the frame assembly.

In order to provide additional heat-insulating properties to the frame assembly, one or more gaskets may be provided on an underside of the inner frame portion and the outer frame portion. For example, one or more gaskets may be provided on the underside of a bottom jamb of a door or window frame. The one or more gaskets may seal at least one of the one or more thermal breaks. Furthermore, the one or more gaskets may comprise a wedge-shaped portion for receiving and engaging with a sill of the door or window. According to some embodiments, one or more gaskets may extend along the entire periphery of the frame. In addition to improving the overall heat-insulating properties of the frame assembly, gaskets may furthermore prevent the ingress of moisture and/or air into the interior of the frame assembly.

Turning now to the drawings, embodiments of the disclosure will be described in detail.

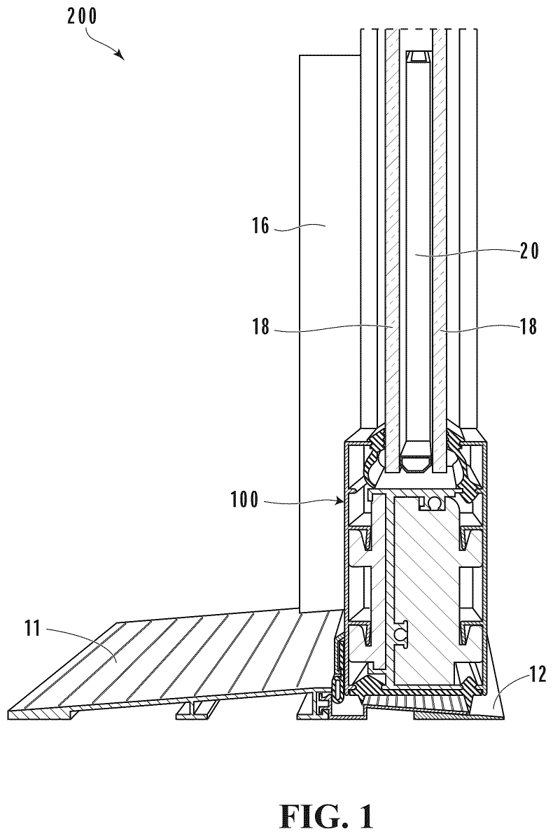

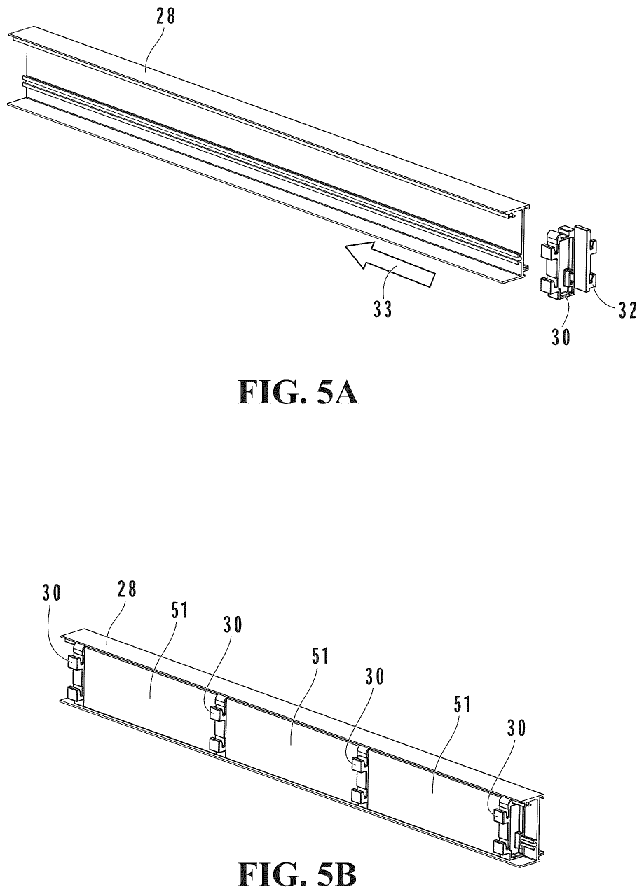

Referring first to FIG. 1, there is shown a cross-sectional view of a door 200 according to an embodiment of the disclosure. Door 200 includes a rectangular frame assembly 100 described in further detail below. Frame assembly 100 includes a pair of vertical jambs and a pair of horizontal jambs that are interconnected to form a door frame, the construction of which is described in further detail in connection with FIGS. 5A-14. Frame assembly 100 is used to secure in place dual sheets of glazing 18 or other glazing infill material. According to some embodiments, a single sheet of glazing may be used, or more than two sheets of glazing.

Door 200 additionally includes a ramped interior sill 11 and a ramped exterior sill 12 that engage with a pair of sill gaskets provided along a bottom of the bottom jamb of frame assembly 100, as described in further detail below. Door 200 further includes a door frame 16 that connects to the wall, and a spacer bar 20 separating double-glazed unit 18.

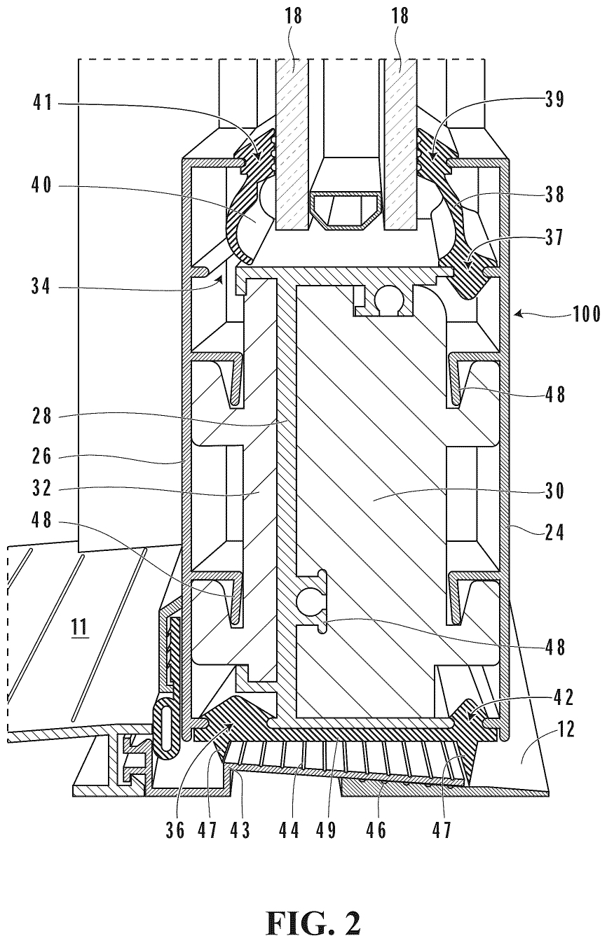

FIG. 2 shows the internal structure of frame assembly 100 in greater detail. Frame assembly 100 includes an inner frame portion 26 facing an interior of the structure or building into which door 200 is set. Frame assembly 100 further includes an outer frame portion 24 facing an exterior of the structure or building into which door 200 is set. Between inner frame portion 26 and outer frame portion 24 is provided a central frame portion 28. Central frame portion 28 is spaced from each of inner frame portion 26 and outer frame portion 24 by a number of gaps that may be referred to as “thermal breaks” 34. Thermal breaks 34 prevent inner frame portion 26, central frame portion 28, and outer frame portion 24 from directly touching each other, and consequently from unimpededly conducting heat through each other.

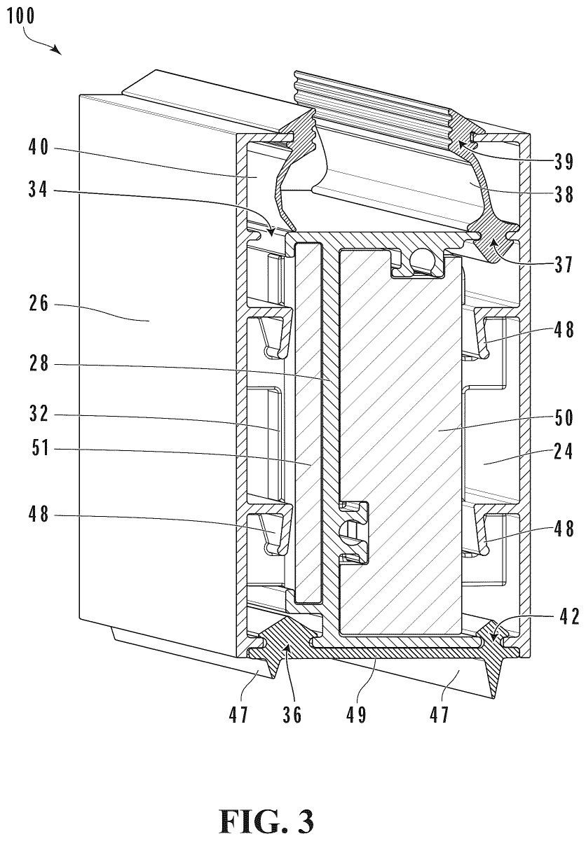

As described in further detail below, alternating sequences of structural portions and heat-insulating portions are provided between inner frame portion 26 and outer frame portion 24. Specifically, a first alternating sequence of structural portions and heat-insulating portions is provided between outer frame portion 24 and central frame portion 28, and a second alternating sequence of structural portions and heat-insulating portions is provided between inner frame portion 26 and central frame portion 28. The cross-section shown in FIGS. 1 and 2 extends through a pair of structural portions 30, 32, whereas the cross-section shown in FIG. 3 (described in further detail below) extends through a pair of heat-insulating portions 50, 51.

As shown in FIG. 2, a first structural portion or “shear block” 30 is provided between outer frame portion 24 and central frame portion 28. A second structural portion or “shear block” 32 is provided between inner frame portion 26 and central frame portion 28. Each shear block 30, 32 is formed of Polyamide 6 with 30% glass fibre (PA6+GF30); however, other materials such as polyamides may additionally or alternatively be used to construct shear blocks 30, 32. A purpose of shear blocks 30, 32 is to hold central frame portion 28 in a fixed position (either directly or indirectly) relative to inner frame portion 26 and outer frame portion 24.

For example, as can be seen in FIG. 2, inner frame portion 26, outer frame portion 24, and central frame portion 28 each comprise a number of hooks 48 or similar features that engage, by snap fitting or pressure fitting, with corresponding grooves or similar features provided in shear block 30 and shear block 32. Because of the nature of the engagement of hooks 48 with the grooves provided in shear block 30 and shear block 32, there is no need to crimp any of hooks 48 in order to provide a secure engagement between inner frame portion 26, outer frame portion 24, and central frame portion 28, and shear block 30 and shear block 32. According to other embodiments, different cooperating features may be used to fix central frame portion 28 in position relative to inner frame portion 26 and outer frame portion 24.

By avoiding crimping, when the exterior surface of the door heats up from exposure to the sun, it is allowed to expand independently from the inner aluminum structure of the door, reducing the risk of bowing.

At the tops of inner frame portion 26 and outer frame portion 24 (i.e. where inner frame portion 26 and outer frame portion 24 generally meet double-glazed unit 18), a pair of gaskets are provided. In particular, an interior glazing gasket 40 is received within a thermal break 41 between outer frame portion 24 and double-glazed unit 18. Glazing gasket 40 includes a portion that sealingly contacts central frame portion 28. Furthermore, an exterior glazing gasket 38 is received within a thermal break 39 between inner frame portion 26 and double-glazed unit 18. Glazing gasket 38 may include a portion that seals a thermal break 37 provided between central frame portion 28 and inner frame portion 26.

In addition to glazing gaskets 38 and 40, three additional gaskets are provided at the bottom of inner frame portion 26, central frame portion 28, and outer frame portion 24 (i.e. where inner frame portion 26 and outer frame portion 24 respectively meet interior and exterior sills 12 and 11). In particular, a sash gasket 49 is provided along the underside of inner frame portion 26, outer frame portion 24, and central frame portion 28, and may seal a thermal break 36 provided between outer frame portion 24 and central frame portion 28 as well as a thermal break 52 provided between central frame portion 28 and inner frame portion 26. An exterior sill gasket 35 is also provided between outer frame portion 24 and exterior sill 11, while an insulating base 43, that may comprise Polyamide 66 with 25% glass fibre extrusion, is provided in contact with interior and exterior sills 12 and 11. Insulating base 43 is designed to provide a thermal break for the threshold of the door.

Insulating base 43 includes a wedge-shaped portion 44 that sealingly engages with interior sill 12. The sealing is improved by the use of ridges or similar features on wedge-shaped portion 44 that are received in or otherwise mate with corresponding grooves or similar features in interior sill 12. Sash gasket 49 includes a pair of protrusions or flaps 47 that extend downwardly and contact ends of wedge-shaped portion 44.

Generally, glazing gaskets 38 and 40, sash gasket 49, and sill gaskets 35, as well as insulating base 43, improve the overall heat-insulating properties of frame assembly 100, and may furthermore prevent the ingress of moisture and/or air into the interior of frame assembly 100. The gaskets may be made of one or more suitable resiliently deformable materials such Santoprene™ or thermoplastic vulcanizates

Turning to FIG. 3, there is shown another view of the internal structure of frame assembly 100 in greater detail. FIG. 3 is similar to FIG. 2, and like elements are numbered using like reference numbers. However, unlike FIG. 2, the cross-section presented in FIG. 3 extends through a pair of heat-insulating portions instead of a pair of structural portions.

In particular, a pair of heat-insulating portions, or “foam blocks”, are provided within the interior of frame assembly 100. These may be manufactured from polyurethane, for example. Other materials could include polystyrene, GPS, aerogel, or any suitable insulating material.

More particularly, a first foam block 50 is provided between outer frame portion 24 and central frame portion 28, and a second foam block 51 is provided between central frame portion 28 and outer frame portion 24. Unlike shear blocks 30 and 32, foam blocks 50 and 51 generally do not provide any structural support to frame assembly 100, and in particular do not actively engage hooks 48 provided on outer frame portion 24, central frame portion 28, and inner frame portion 26. A purpose of foam blocks 50 and 51 is to provide heat insulation and therefore inhibit the transfer of heat between outer frame portion 24, central frame portion 28, and inner frame portion 26.

As described above and in further detail below, a first alternating sequence of shear blocks and foam blocks is provided between outer frame portion 24 and central frame portion 28, and a second alternating sequence of shear blocks and foam blocks is provided between central frame portion 28 and inner frame portion 26. For example, as can be seen in FIG. 3, a shear block 30 is located behind foam block 50.

According to some embodiments, the heat-insulating portions may simply be hollow portions of the frame (i.e. the heat-insulating portions may consist of air), in which case each insulating and structural assembly comprises a sequence of spaced-apart shear blocks. Advantageously, the foam blocks may act as spacers that space-apart the shear blocks by a preset distance (i.e. the length of the foam blocks). However, if air is intended to be used as the insulating medium, then the shear blocks may be secured to inner frame portion 26, outer frame portion 24, and central frame portion 28 using caulking, for example.

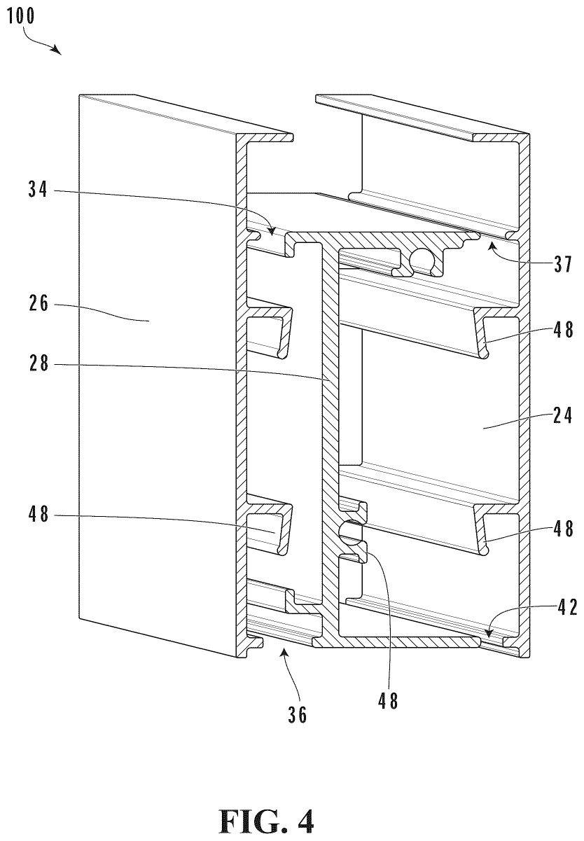

FIG. 4 shows outer frame portion 24, central frame portion 28, and inner frame portion 26 in greater detail, including hooks 48 and various thermal breaks 34, 36, 37, and 42.

Turning now to FIGS. 5A-14, there is shown and described a method of assembling frame assembly 100 of door 200.

In FIGS. 5A and 5B, there is shown heat-insulating and structural assemblies (comprising structural shear blocks and heat-insulating foam blocks) being coupled to a central frame portion of a top or a bottom jamb of frame assembly 100. In particular, a first shear block 32 and a second shear block 30 are engaged with central frame portion 28 by sliding shear block 32 and shear block 30 onto central frame portion 28, as shown by directional arrow 33. For example, hooks 48 on central frame portion 28 may be aligned with corresponding grooves provided in shear blocks 30 and 32, and shear blocks 30 and 32 are then slid along central frame portion 28 while in engagement with central frame portion 28 as a result of the mating of hooks 48 with the corresponding grooves.

Once shear blocks 30 and 32 have been slid to their desired location along central frame portion 28, a heat-insulating foam block 50 is then slid onto central frame portion 28 in the direction of arrow 33, until foam block 50 is adjacent shear blocks 30 and 32. Subsequently, another pair of shear blocks 30 and 32 are slid onto central frame portion 28 in the direction of arrow 33 until this pair of shear blocks 30 and 32 is brought adjacent foam block 50. Subsequently, another foam block 50 is then slid onto central frame portion 28 in the direction of arrow 33 until this foam block 50 is brought into contact with the second pair of shear blocks 30 and 32. Therefore, alternating sequences of structural portions (shear blocks 30 and 32) and heat-insulating portions (foam blocks 50) are joined to with central frame portion 28, with shear blocks 30 and 32 actively secured to central frame portion 28.

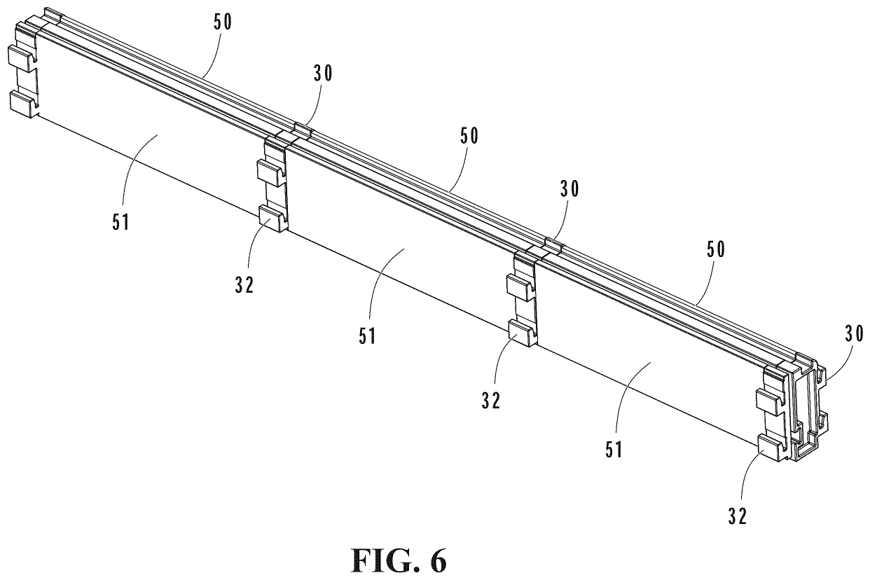

FIG. 6 shows the arrangement of alternating sequences of structural portions (shear blocks 30, 32) and heat-insulating portions (foam blocks 50, 51) in the absence of other components of frame assembly 100. As can be seen, each foam block 50, 51 is longer, in the longitudinal direction, than each shear block 30, 32. Each foam block 50, 51 is 12 inches long and each shear block 30, 32 is one inch long in the depicted embodiment; however, any one or more of the blocks 30, 32, 50, 51 may have different lengths in other embodiments. Generally speaking, the foam blocks 50, 51 are longer than the shear blocks 30, 32 for the purpose of increasing thermal insulation. Therefore, contact between frame portions 24, 26, and 28, and shear block 30 and 32, may be minimized, while contact between frame portions 24, 26, and 28, and foam blocks 50 and 51, may be maximized.

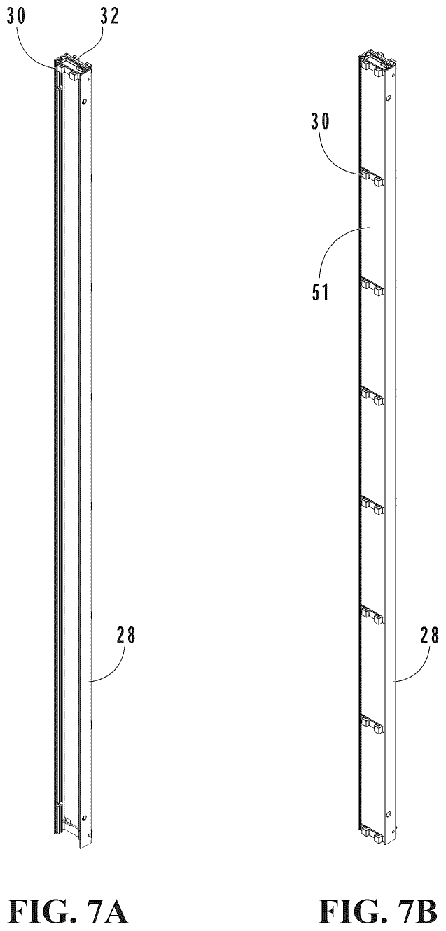

Turning to FIGS. 7A and 7B, the process shown in FIGS. 5A and 5B is repeated for a pair of vertical, side jambs of frame assembly 100. As can be seen in FIGS. 7A and 7B, a pair of alternating sequences of structural portions and heat-insulating portions are joined to a central frame portion 28 of a side jamb.

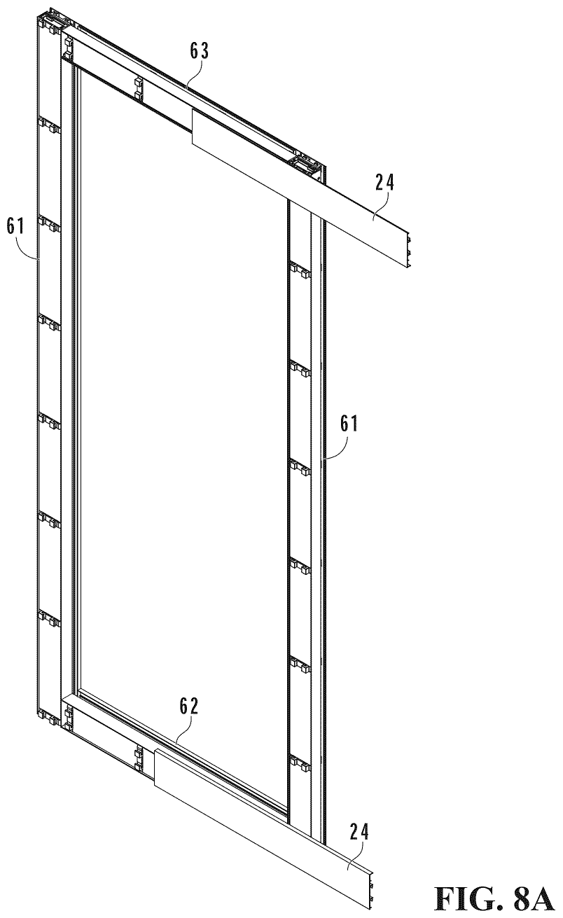

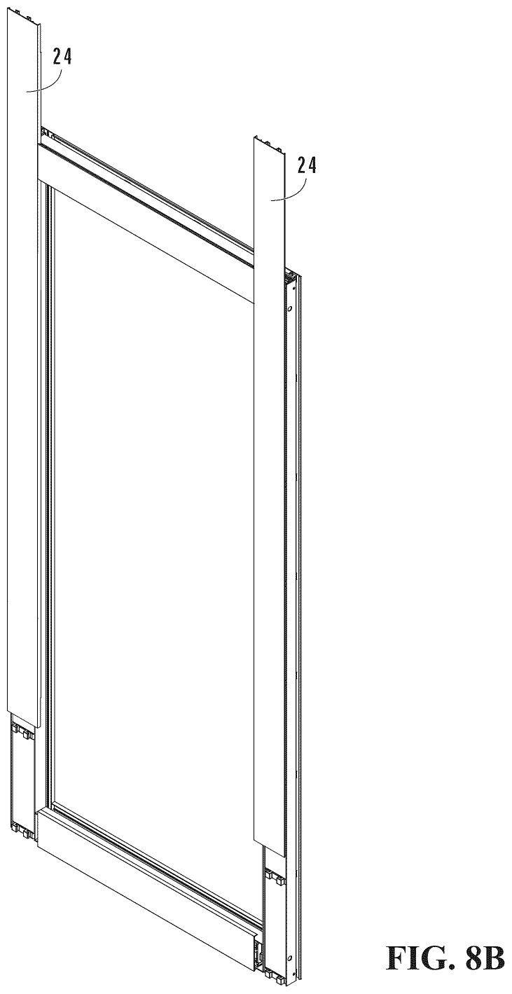

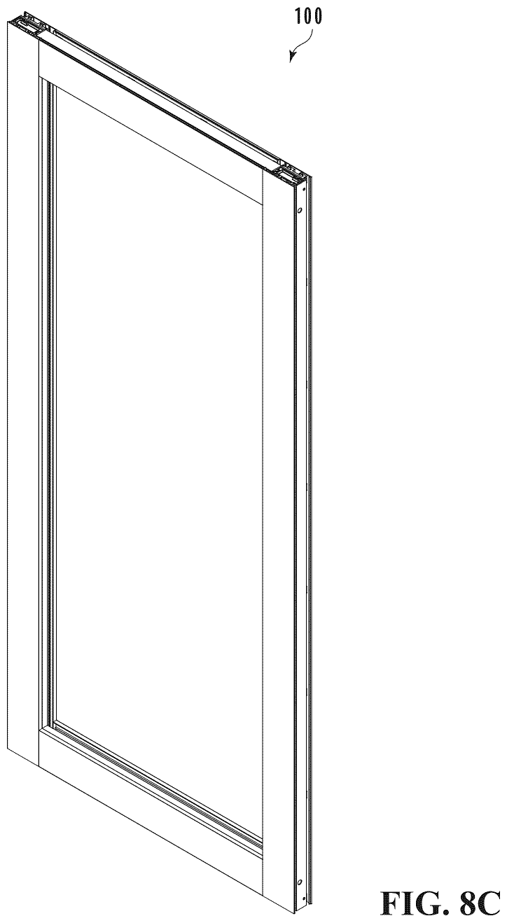

Turning to FIGS. 8A-8C, there are shown interconnected side jambs 61, a bottom jamb 62, and a top jamb 63. After interconnection of each of the jambs, inner frame portions 26 are then attached to each jamb of frame assembly 100, by sliding inner frame portion 26 into engagement with shear blocks 32 of the jamb, or alternatively by snapping inner frame portion 26 into engagement with shear blocks 32. For example, as before, hooks 48 provided on inner frame portion 26 are aligned with corresponding grooves provided in shear blocks 32, prior to sliding inner frame portion 26 into engagement with shear blocks 32. Thus, as a result of the sliding of inner frame portion 26 relative to shear blocks 32 (or the snapping of inner frame portion 26 into engagement with shear blocks 32), hooks 48 of inner frame portion 26 engage with grooves in shear blocks 32, and inner frame portion 26 is secured in position relative to central frame portion 28. Partially-completed frame assembly 100 is shown in FIG. 8C, with each jamb having an inner frame portion 26 added thereto.

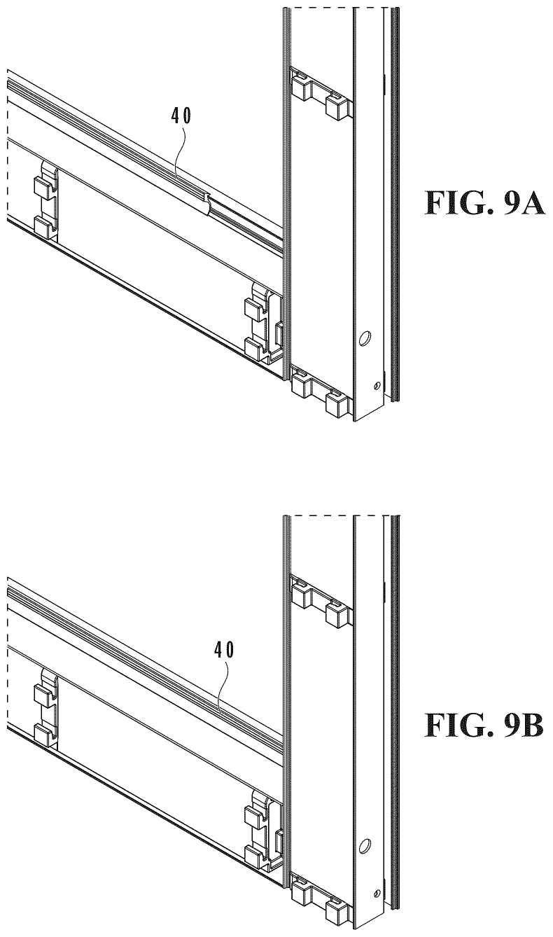

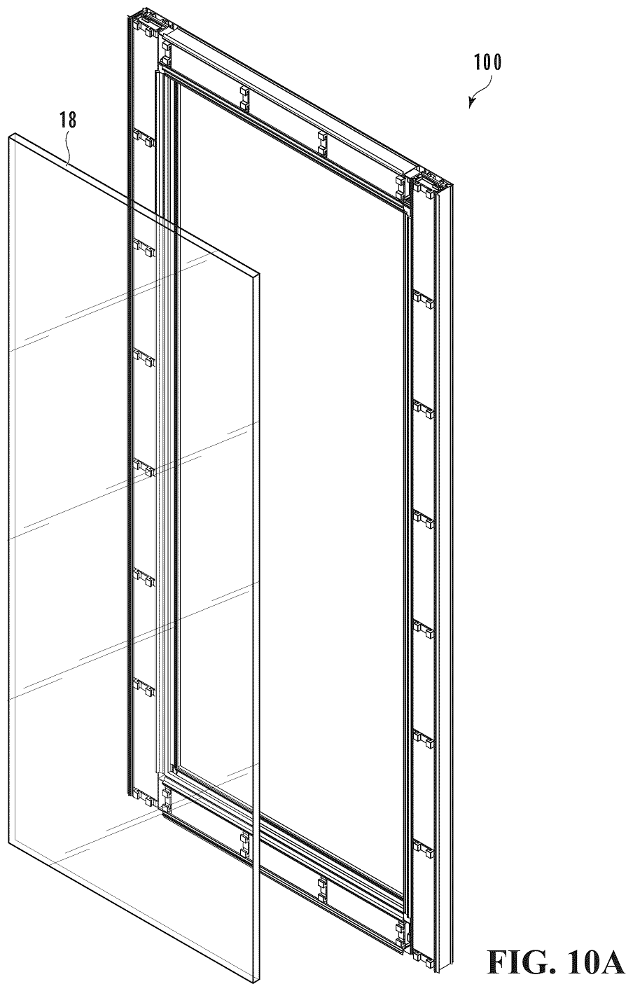

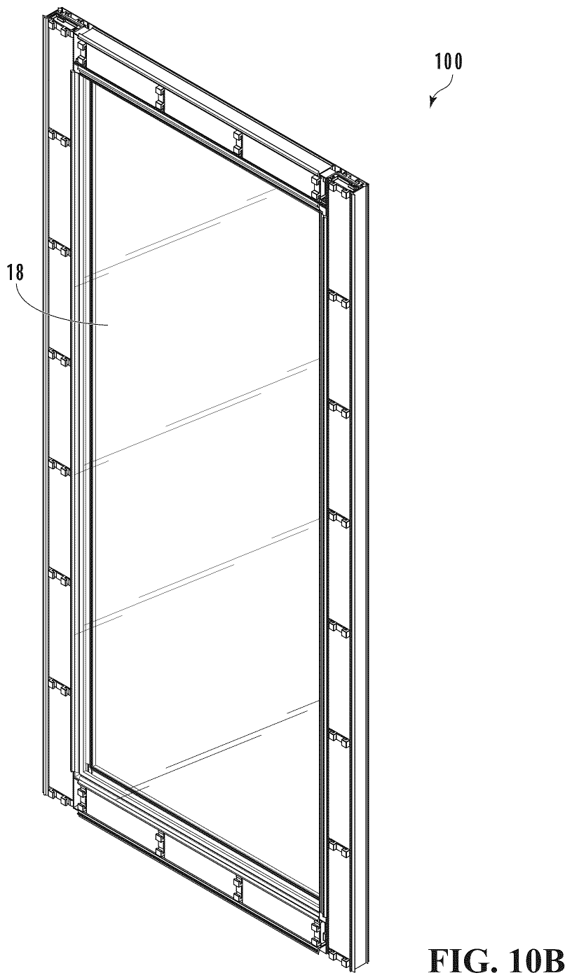

Turning now to FIG. 9, interior glazing gasket 40 is inserted into position by being received within and sealing thermal break 41, as described above. As then shown in FIGS. 10A and 10B, once interior glazing gasket 40 is in position, double-glazed unit 18 is placed onto interior glazing gasket 40. Advantageously, double-glazed unit 18 is secured to frame assembly 100 by each jamb (side jambs 61, bottom jamb 62, and top jamb 63) of door 200, both on the exterior and interior sides of door 200.

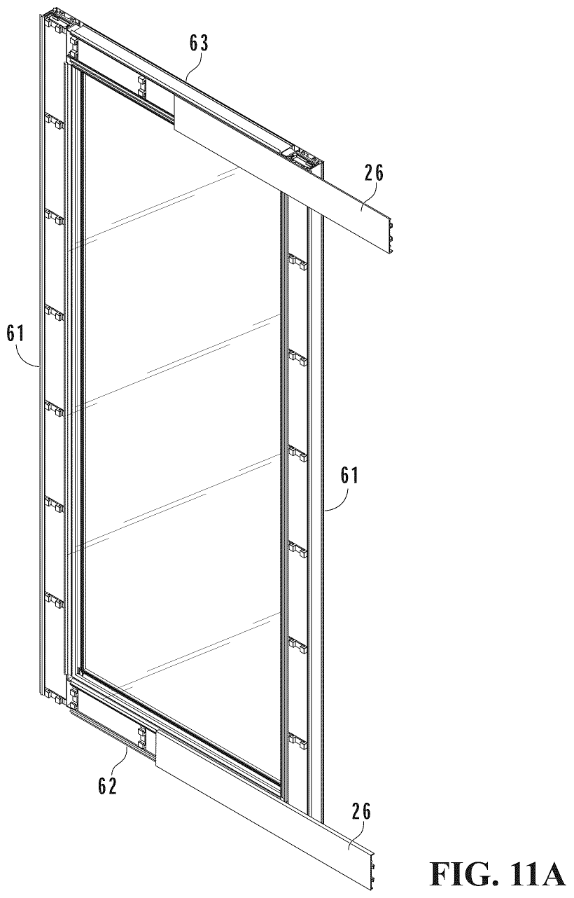

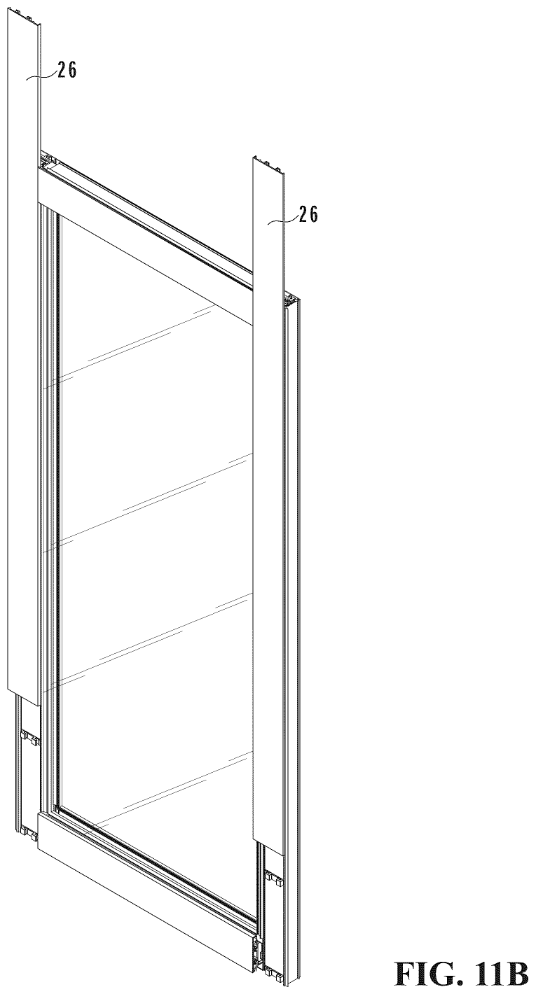

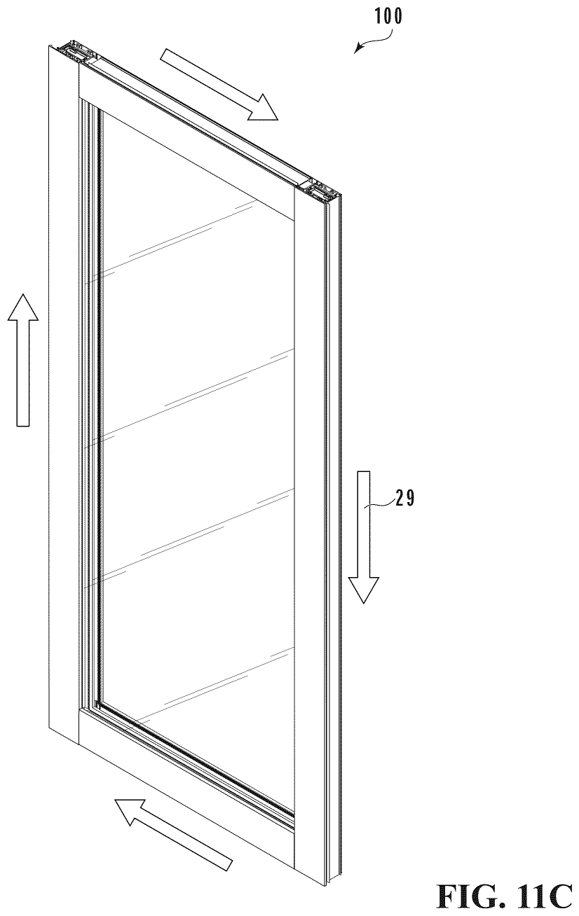

Once double-glazed unit 18 has been positioned, outer frame portions 24 are then provided on each jamb 61, 62, 63 of frame assembly 100, as shown in FIGS. 11A-11C. In particular, outer frame portions 24 are attached to each jamb of frame assembly 100 by sliding outer frame portions 24 into engagement with shear blocks 30 of each jamb, or alternatively by snapping outer frame portions 24 into engagement with shear blocks 30 of each jamb. For example, as before, hooks 48 provided on outer frame portions 24 are aligned with corresponding grooves provided in shear blocks 30, prior to sliding outer frame portions 24 into engagement with shear blocks 30. Thus, as a result of the sliding of outer frame portions 24 relative to shear blocks 30 (or the snapping of outer frame portions 24 into engagement with shear blocks 30), hooks 48 of outer frame portions 24 engage with grooves in shear blocks 30, and outer frame portions 24 are secured in position relative to central frame portion 28. Partially-completed frame assembly 100 is shown in FIG. 11C, with each jamb having an outer frame portion 24 added thereto.

As can be seen in FIG. 11C, the different frame portions (i.e., outer frame portion 24, central frame portion 28, and inner frame portion 26) of the different jambs 61, 62, and 63 that make up the door frame define respective longitudinal directions that extend peripherally around the door frame, as indicated by directional arrow 29. Therefore, the insulating and structural assemblies (comprising heat-insulating portions and structural portions, as described above) in the jambs also extend in the longitudinal direction and around the periphery of the door frame.

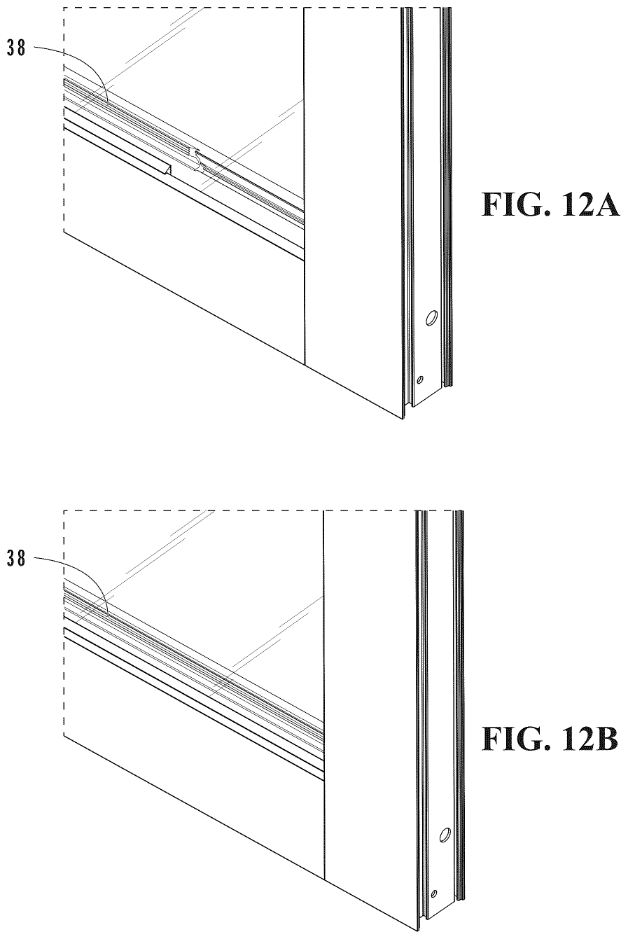

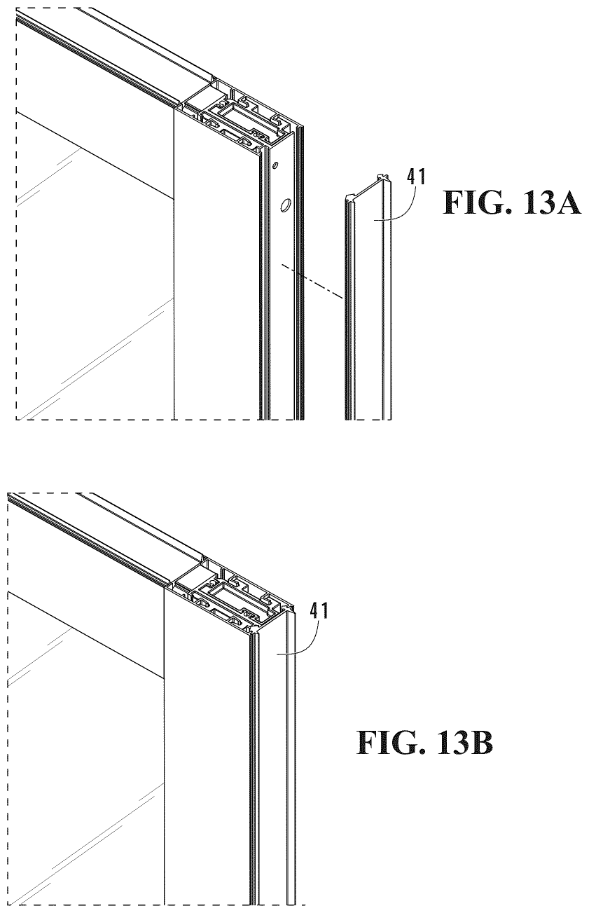

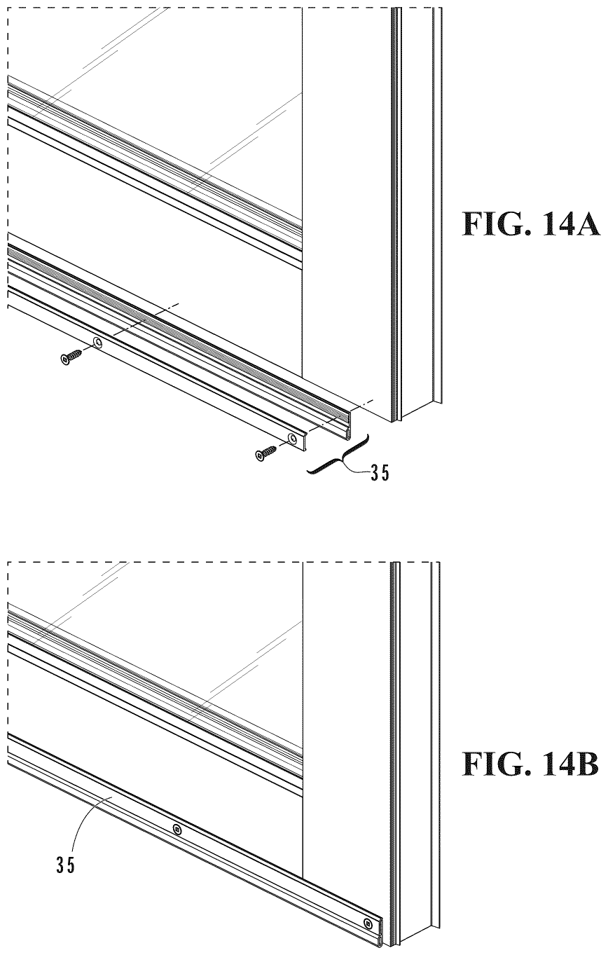

Turning to FIG. 12, exterior glazing gasket 38 is inserted into position by being received within and sealing thermal breaks 37 and 39, as described above. As then shown in FIG. 13, sash gasket 49 is provided on the underside of bottom jamb 62. Sash gasket 49 is also applied to each other jamb of frame assembly 100. And, as then shown in FIG. 14, exterior sill gasket 50 is secured to outer frame portion 24.

Embodiments of the frame assembly described herein may be equally-well used in combination with a window, such as an opening window or a fixed window, instead of a door.

While the embodiments of the frame assembly have generally been described in the context of multiple, separate components being brought together and assembled into a final structure, it shall be understood that the frame assembly described herein extends to frames that comprise components integrally or monolithically formed. For example, the alternating sequence of structural portions and heat-insulating portions may comprise structural portions and heat-insulating portions that are integrally bonded or otherwise connected together, such that the entire alternating arrangement of structural portions and heat-insulating portions may be inserted as one between the different frame portions.

According to some embodiments, the frame assembly may use only a pair of frame portions (i.e. an outer frame portion and an inner frame portion), and may dispense with the central frame portion.

According to some embodiments, the frame assembly described herein does not need to extend around the entire periphery of the door/window frame, and instead may extend only partway around the frame.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A frame assembly for a door or a window, comprising:
an inner frame portion;
an outer frame portion spaced from the inner frame portion by one or more thermal breaks; and
a first insulating and structural assembly positioned between the inner frame portion and the outer frame portion, and comprising:
heat-insulating portions for inhibiting the transfer of heat between the inner frame portion and the outer frame portion; and
structural portions for retaining the inner frame portion in position relative to the outer frame portion,
wherein the inner frame portion and the outer frame portion define a longitudinal direction extending peripherally around the door or window, and
wherein the heat-insulating portions alternate in the longitudinal direction with the structural portions.

2. The frame assembly of claim 1, wherein the one or more thermal breaks comprise one or more air gaps.

3. The frame assembly of claim 1, further comprising a central frame portion respectively spaced from and between each of the inner frame portion and the outer frame portion by one or more thermal breaks, and wherein the structural portions further retain the inner frame portion and the outer frame portion in position relative to the central frame portion.

4. The frame assembly of claim 3, wherein:
the heat-insulating portions comprise:
heat-insulating portions positioned between the inner frame portion and the central frame portion; and
heat-insulating portions positioned between the central frame portion and the outer frame portion; and
the structural portions comprise:
structural portions securing the inner frame portion to the central frame portion; and
structural portions securing the central frame portion to the outer frame portion.

5. The frame assembly of claim 1, wherein the heat-insulating portions comprise polystyrene foam.

6. The frame assembly of claim 1, wherein the heat-insulating portions are hollow portions of the frame assembly.

7. The frame assembly of claim 1, wherein the structural portions comprise one or both of a polyamide and glass fibre.

8. The frame assembly of claim 1, wherein the inner frame portion and the outer frame portion comprise features for mating with corresponding features in the structural portions.

9. The frame assembly of claim 7, wherein the features of the inner frame portion and the outer frame portion, and the corresponding features in the structural portions, are uncrimped.

10. The frame assembly of claim 1, wherein:
at least one of the inner frame portion and the outer frame portion comprises hooks for mating with corresponding grooves in the structural portions; or
the structural portions comprise hooks for mating with corresponding grooves in at least one of the inner frame portion and the outer frame portion.

11. The frame assembly of claim 1, further comprising one or more gaskets sealing at least one of the one or more thermal breaks.

12. The frame assembly of claim 11, wherein the one or more gaskets include at least one gasket on an underside of the inner frame portion and the outer frame portion and comprising one or more downwardly extending protrusions for sealing against a threshold of the door or window.

13. The frame assembly of claim 1, wherein at least one of the heat-insulating portions is longer, in the longitudinal direction, than at least one of the structural portions.

14. The frame assembly of claim 13, wherein each of the heat-insulating portions is longer, in the longitudinal direction, than each of the structural portions.

15. A door comprising:
a sill;
a frame assembly comprising:
an inner frame portion;
an outer frame portion spaced from the inner frame portion by one or more thermal breaks; and
an insulating and structural assembly positioned between the inner frame portion and the outer frame portion, and comprising:
heat-insulating portions for inhibiting the transfer of heat between the inner frame portion and the outer frame portion; and
structural portions for retaining the inner frame portion in position relative to the outer frame portion,
wherein the inner frame portion and the outer frame portion define a longitudinal direction extending peripherally around the door, and
wherein the heat-insulating portions alternate in the longitudinal direction with the structural portions.

16. The door of claim 15, further comprising at least one gasket on an underside of the inner frame portion and the outer frame portion and comprising a wedge-shaped portion receiving the sill.

17. The frame assembly of claim 16, wherein the wedge-shaped portion comprises one or more grooves or one or more protrusions formed therein for respectively receiving one or more protrusions or one or more ridges of the sill.

18. A method of making a frame for a door or a window, comprising:
providing:
an inner frame portion;
an outer frame portion spaced from the inner frame portion by one or more thermal breaks; and
an insulating and structural assembly between the inner frame portion and the outer frame portion,
wherein providing the insulating and structural assembly comprises sliding, in a longitudinal direction defined by the inner frame portion and the outer frame portion, structural portions between the inner frame portion and the outer frame portion and such that the structural portions are spaced apart from one another in the longitudinal direction,
wherein, as a result of sliding the structural portions between the inner frame portion and the outer frame portion, features on the structural portions mate with corresponding features on the inner frame portion and the outer frame portion and thereby retain the inner frame portion in position relative to the outer frame portion.

19. The method of claim 18, wherein sliding the structural portions comprises:
alternately sliding, in the longitudinal direction defined by the inner frame portion and the outer frame portion, heat-insulating portions and the structural portions between the inner frame portion and the outer frame portion,
wherein the heat-insulating portions are for inhibiting the transfer of heat between the inner frame portion and the outer frame portion.

20. The method of claim 18, wherein, after sliding the structural portions between the inner frame portion and the outer frame portion, the features on the structural portions and the corresponding features on the inner frame portion and the outer frame portion are not crimped.
